(19) United States
(12) Patent Application Publication
(10) Pub. No.: US 2017/0295099 A1
(43) Pub. Date: Oct. 12, 2017

(54) SYSTEM AND METHOD OF LOAD BALANCING ACROSS A MULTI-LINK GROUP

(71) Applicant: Arista Networks, Inc., Santa Clara, CA (US)

(72) Inventor: James Murphy, Alameda, CA (US)

(21) Appl. No.: 15/096,148

(22) Filed: Apr. 11, 2016

(51) Int. Cl. H04L 12/803; H04L 12/721; H04L 12/707; H04L 12/801; H04L 12/865

(52) U.S. Cl. CPC H04L 47/125; H04L 47/34; H04L 47/6275; H04L 45/24; H04L 45/123; H04L 45/38

(57) ABSTRACT

A method and apparatus of a device that queues an out-of-order packet received on a multi-link group is described. In an exemplary embodiment, the device receives a packet on a link of the multi-link group of a network element, where the packet is part of a data flow. The device further examines the packet, if the packet is associated with a re-orderable route. In addition, the device examines the packet by retrieving a packet sequence number from the packet and comparing the packet sequence number with the last received sequence number for this data flow. The device transmits the packet if the packet is a next packet in the data flow. If the packet is out-of-order, the device queues the packet.

### FIELD OF INVENTION

This invention relates generally to data networking, and more particularly, to load balancing transmitted data across a multi-link group in a network.

### BACKGROUND OF THE INVENTION

A network can take advantage of a network topology that includes a multi-link group from one host in the network to another host. This multi-link group allows network connections to increase throughput and provide redundancy in case a link in the equal cost segment group goes down. A multi-link group can be an aggregation of links from one network device connected to another device or a collection of multiple link paths between network devices. An example of a multi-link group is an Equal Cost Multipath (ECMP) and Link Aggregation Groups (LAG).

There are number of ways that a network element can use to select which link in a multi-link group to transport the packet to a destination device. The network element can use a round-robin link selection mechanism, a load based link selection mechanism, a hash-based link selection mechanism, or a different type of link selection mechanism. The round-robin link selection mechanism is a link selection mechanism that rotates through different ones of the links to use to transmit packets. The network element can also use a load-based link selection mechanism, where the network element selects a link based on the load some of the intermediary network elements are experiencing. For example, the network element would select a link for one of the intermediary network elements that has either the lowest load or a low load at the time of packet transmission. In one embodiment, each of the round robin and link based selection mechanisms are efficient at spreading out the load among different links and intermediary network elements. These link selection mechanisms, however, have a problem in that packets for certain data flows of packets may arrive out of order. This can be a problem for sequenced packets in a dataflow that are meant to arrive in order. For example, if the packets are part of a Transport Control Protocol (TCP) session, out-of-order packets can be treated as a signal for congestion by many TCP implementations. If the TCP stack detects congestion, then either of the hosts in this TCP session may transmit the packets at a lower rate.

In order to avoid the reordering of packets within a dataflow, the network element can use a hash-based link selection mechanism, where a link is selected based on a set of certain packet characteristics. Using a hash-based link selection mechanism allows for the packets in a dataflow (e.g., a TCP session) to be transmitted on the same link in via the same spine network element to the destination host. This reduces or eliminates out of order packets. A problem with hash-based link selection mechanisms is that this type of selection mechanism is not as efficient in spreading the load among the different links and intermediary network elements.

### SUMMARY OF THE DESCRIPTION

A method and apparatus of a device that queues an out-of-order packet received on a path that includes multi-link group is described. In an exemplary embodiment, the device receives a packet on a link of the multi-link group of a network element, where the packet is part of a data flow. The device further examines the packet, if the packet is associated with a re-orderable route. In addition, the device examines the packet by retrieving a packet sequence number from the packet and comparing the packet sequence number with the last received sequence number for this data flow. The device transmits the packet if the packet is a next packet in the data flow. If the packet is out-of-order, the device queues the packet.

In another embodiment, a device advertises a re-orderable route. In this embodiment, the device determines that the route is the re-orderable route, wherein a re-orderable route is a route to a destination that is associated with a queue to store an out-of-order packet. The device further advertises the route using a routing protocol from the network element to other network elements coupled to this network element in a network, wherein in the advertised route includes an indication that this route is the re-orderable route.

In a further embodiment, the device selects a link from a multi-link group coupled to the device. In this embodiment, the device receives a packet on the network element. The device further determines a next hop route for the packet, where the next hop route includes multi-link group that include a plurality of interfaces. The device additionally designates a first link selection mechanism as a link selection mechanism if the next hop route is a re-orderable route. Furthermore, the device designates a second link selection mechanism as the link selection mechanism if the next hop route is not a re-orderable route. The device additionally selects a transmission interface from the plurality of interfaces using the link selection mechanism. The device further transmits the packet using the transmission interface.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 is a block diagram of one embodiment of a network with a multi-link group between a wide area network (WAN) network element and spine network elements and a multi-link group between the spine network elements and leaf network elements.

FIG. 2 is a block diagram of one embodiment of source network element coupled to a destination network element.

FIG. 3 is a block diagram of one embodiment of a lookup table used to keep track of queues to store out of order packets for the data flows.

FIG. 4A is a flow chart of one embodiment of a process to queue an out-of-order packet received on a path that includes a multi-link group.

FIG. 4B is a flow chart of one embodiment of a process to handle a timer for a queue flushing operation.

FIG. 5 is a flow diagram of one embodiment of a process to determine a link selection mechanism for transmitting a packet on a multi-link group.

FIG. 6 is a flow chart of one embodiment of a process to advertise a re-orderable route.

FIG. 7 is a flow diagram of one embodiment of a process to install a re-orderable route in a routing table.

FIG. 8 is a block diagram of one embodiment of a queuing module that queues an out-of-order packet received on a multi-link group.

FIG. 9 is a block diagram of one embodiment of a timer module to handle a timer for a queue flushing operation.

FIG. 10 is a block diagram of one embodiment of a link selection module to determine a link selection mechanism for transmitting a packet on a multi-link group.

FIG. 11 is a block diagram of one embodiment of an advertise route module to advertise a re-orderable route.

FIG. 12 is a block diagram of one embodiment of an install route module to advertise a re-orderable route in a routing table.

FIG. 13 illustrates one example of a typical computer system, which may be used in conjunction with the embodiments described herein.

FIG. 14 is a block diagram of one embodiment of an exemplary network element that queues out of order packets.

### DETAILED DESCRIPTION

A method and apparatus of a device that queues an out-of-order packet received on a path that includes multi-link group is described. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device that queues an out-of-order packet received on a path that includes a multi-link group is described. In one embodiment, the device tracks and queues out-of-order packets of a dataflow of sequenced packets transported between two hosts. In this embodiment, the device receives a packet and characterizes that packet to determine which dataflow the packet belongs to. In this embodiment, the device looks up the packet in a lookup table using some of the packet characteristics (e.g., the source and destination Internet Protocol (IP) addresses, source and destination port number, and protocol type). In addition, the device compares the sequence number of the received packet to the largest sequence number transmitted of this dataflow. If the packet sequence number is the next sequence number, this packet is in order and the device transmits the packet to the destination. If the packet sequence number is greater than the next sequence number, this packet is out of order and the device queues this packet in case the device receives another packet with the next sequence number so that the received packet and the other packet are in order. When the queued packet(s) are in order, the device transmits the now in order packets to the destination.

In one embodiment, the device includes a timer that limits the amount of time an out of order packet can remain in the queue. In this embodiment, the device starts the timer when a packet is stored in the queue and has a length of approximately the round trip time of packets in this dataflow. If the timer fires and this packet remains in the queue, the device flushes the queue. In one embodiment, the timer length can be computed from the source IP address, the topology, and information about the link speeds and maximum buffer queue sizes for links from the network element making the first multi-link next hop decision to the queuing network element. The link speeds and buffer queue sizes are provided to the queuing network element via the routing protocol.

In a further embodiment, because the device can queue out of order packets for a data flow to the destination, the device advertises that the route to this destination as re-orderable. In this embodiment, a re-orderable route is a is a route to a local subnet or host(s) where the destination network element has one or more queue(s) to track data flow(s) for out-of-order packet(s) for these data flow(s). In one embodiment, the device advertises the re-orderable route using a routing protocol that includes an extension used to indicate that this route is re-orderable. By advertising this re-orderable route, other network elements can take advantage of the re-orderable route.

In another embodiment, a device determines which link of the multi-link group to transmit a packet. In order to determine which link to transmit the packet, the device determines what type of link selection mechanism to use for the multi-link group. To determine what type of link selection mechanism the device will use, the device determines what type of route is used for the packet. If the route for the packet is a re-orderable route, the device can use a round-robin or load-based link selection mechanism. If the packet is not a re-orderable route, the device can use a hash-based link selection mechanism. In this embodiment, each of the round-robin or load-based link selection mechanism is a more efficient mechanism at spreading the load across the multiple links in a multi-link group.

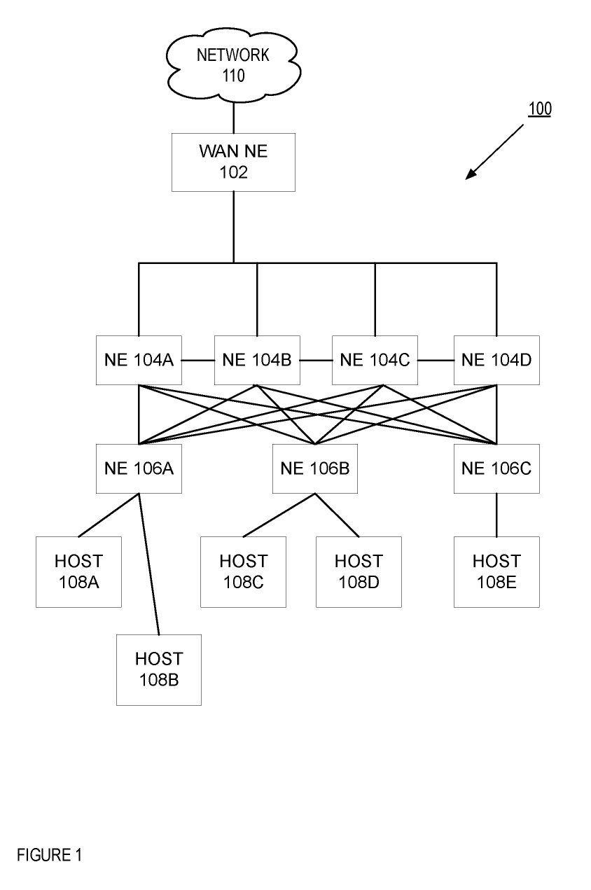

FIG. 1 is a block diagram of one embodiment of a network with a multi-link group between a wide area network (WAN) network element 102 and spine network elements 104A-D and a multi-link group between the spine network elements 104A-D and leaf network elements 106A-C. In FIG. 1, the network 100 includes spine network elements 104A-D that are coupled to each of the leaf network elements 106A-E. The leaf network element 106A is further coupled to hosts 108A-B, leaf network element 106B is coupled to hosts 108C-D, and leaf network element 106C is coupled to network element 108E. In one embodiment, a spine network element 104A-D is a network element that interconnects the leaf network elements 106A-E. In this embodiment, each of the spine network elements 104A-D is coupled to each of the leaf network elements 106A-E. Furthermore, in this embodiment, each of the spine network elements 104A-D are coupled with each other. While in one embodiment, the network elements 104A-D and 106A-E are illustrated in a spine and leaf topology, in alternate embodiments, the network elements 104A-D and 106A-E can be in a different topology. In one embodiment, each of the network elements 104A-D and/or 106A-E can be a router, switch, bridge, gateway, load balancer, firewall, network security device, server, or any other type of device that can receive and process data from a network. In addition, the WAN network element 102 is a network element that provides network access to the network 110 for network elements 104A-D, network elements 106A-C, and hosts 108A-E. As illustrated in FIG. 1, the WAN network element is coupled to each of the spine network elements 104A-D. In one embodiment, the WAN network element 110 can be a router, switch, or another type of network element that can provide network access for other devices. While in one embodiment, there are four spine network elements 104A-D, three leaf network elements 106A-C, one WAN network element 102, and five hosts 108A-E, in alternate embodiments, there can be more or less numbers of spine network elements, leaf network elements, WAN network element, and/or hosts.

In one embodiment, the network elements 104A-D and 106A-C can be the same or different network elements in terms of manufacturer, type, configuration, or role. For example and in one embodiment, network elements 104A-D may be routers and network elements 106A-C may be switches with some routing capabilities. As another example and embodiment, network elements 104A-D may be high capacity switches with relatively few 10 gigabit (Gb) or 40 Gb ports and network elements 106A-E may be lower capacity switches with a large number of medium capacity port (e.g., 1 Gb ports). In addition, the network elements may differ in role, as the network elements 104A-D are spine switches and the network elements 106A-C are leaf switches. Thus, the network elements 104A-D and 106A-E can be a heterogeneous mix of network elements.

If one of the leaf network elements 106A-C is transmitting a packet to another leaf network element 106A-C, the source network element 106A-C has choice of which spine network element 104A-D to use to forward the packet to the destination leaf network element 106A-C. For example and in one embodiment, if host 108A transmits a packet destined for host 108E, host 108A transmits this packet to the leaf network element coupled to host 108A, leaf network element 106A. The leaf network element 106A receives this packet and determines that the packet is to be transmitted to one of the spine network elements 104A-D, which transmits that packet to the leaf network element 106C. The leaf network element 106C then transmits the packet to the destination host 106E.

Because there can be multiple equal cost paths between pairs of leaf network elements 106A-C via the spine network elements, the network element 106A can use a multi-link group (e.g., equal-cost path (ECMP), multiple link aggregation group (MLAG), link aggregation, or another type of multi-link group). In one embodiment, ECMP is a routing strategy where next-hop packet forwarding to a single destination can occur over multiple “best paths” which tie for top place in routing metric calculations. Many different routing protocols support ECMP (e.g., Open Shortest Path First (OSPF), Intermediate System to Intermediate System (ISIS), and Border Gateway Protocol (BGP)). ECMP can allow some load balancing for data packets being sent to the same destination, by transmitting some data packets through one next hop to that destination and other data packets via a different next hop. In one embodiment, the leaf network element 106A that uses ECMP makes ECMP decisions for various data packets of which next hop to use based on which traffic flow that data packet belongs to. For example and in one embodiment, for a packet destined to the host 108E, the leaf network element 106A can send the packet to any of the spine network elements 104A-D.

In one embodiment, because there are multiple different spine network elements 104A-D the leaf network element 106A can use to transport the packet to the destination leaf network element 106C and host 108E, the leaf network element 106A uses a link selection mechanism to select which one of the links in the multi-link group to the spine network elements 104A-D to transport this packet.

There are number of ways that the leaf network element 106A can use to select which link, and which spine network element 104A-D, is used to transport the packet to the destination host 108E. In one embodiment, the leaf network element 106A can use a round-robin link selection mechanism, a load based link selection mechanism, a hash-based link selection mechanism, or a different type of link selection mechanism. In one embodiment, a round-robin link selection mechanism is a link selection mechanism that rotates through the links used to transmit packets. For example and in one embodiment, if the leaf network element 106A received four packets destined for host 108E, the leaf network element 106A would use the first link and spine network element 104A to transport the first packet, the second link and spine network element 104B to transport the second packet, the third link and spine network element 104C to transport the third packet, and the fourth link and spine network element 104D to transport the fourth packet.

In another embodiment, the leaf network element 106A can use a load-based link selection mechanism, where the leaf network element 106A selects a link based on the load the spine network elements 104A-D are experiencing. In this embodiment, the leaf network element 106A would select a link for the spine network element 104A-D that has either the lowest load or a low load at the time of packet transmission. In one embodiment, each of the round robin and link based selection mechanisms are good at splitting out the load among different links and spine network elements 104A-D. These link selection mechanisms, however, have a problem in that package for certain data flows of packets may arrive out of order. This can be a problem for sequenced packets in a dataflow that are meant to arrive in order. For example and in one embodiment, if the packets are part of a TCP session, out-of-order packets can be treated as a signal for congestion by many TCP implementations. If the TCP stack detects congestion, then either host of the TCP session may transmit packets at a lower rate.

In order to avoid the reordering of packets within a dataflow, the leaf network element 106A can use a hash-based link selection mechanism, where a link is selected based on a set of certain packet characteristics. For example and in one embodiment, the leaf network element 106A can generate a hash based on the source and destination Internet Protocol (IP) addresses, source and destination ports, and type of packet (e.g., whether the packet is a TCP or Uniform Datagram Protocol (UDP) packet). Using a hash-based link selection mechanism allows for the packets in a dataflow to be transmitted on the same link in via the same spine network element 104A-D to the destination host. This reduces or eliminates out of order packets. A problem with hash-based link selection mechanisms is that these types of selection mechanisms is not as efficient in spreading the load among the different links and spine network elements 104A-D. For example and in one embodiment, if two data flows end up with the same link selection, then one link and one of the spine network elements 104A-D would be used for the packets in these data flows and the other links and spine network elements 104A-D would not be used for these packet transports.

In one embodiment, in order to take advantage of the efficiencies of either the round-robin or load based link selection mechanisms without having the issues with regards to out of order packets, a destination network element can set up one or more queues to queue packets that arrive out of order. In this embodiment, a destination network element would set up separate queues for each data flow that this destination network element would track for out of order packets. In one embodiment, a destination network element is a network element coupled to local subnets that can be the last hop (or hop after a multi-link group) on a path to a host on those subnets, where the path includes a multi-link group. For example and in one embodiment, each of the leaf network elements 106A-C and the WAN network element 102 can be destination network elements, as paths leading to these network elements can include multi-link groups along these paths (e.g., paths having multi-link groups involving the spine network elements 104A-D). As another example and embodiment, host 108B transmits TCP packets to host 108E. In this example, TCP packets from host 108B are transmitted via leaf network element 106A through one of the spine network elements 104A-D to the destination network element 106C. The destination network element 106C subsequently transmits those TCP packets to host 108E. Further in this example, the leaf network element 106A would be a source network element and the leaf network element 106C would be a destination network element.

In this embodiment, the destination network element records the largest sequence number of a packet for that dataflow that is been transmitted by the destination network element. For example and in one embodiment, if the destination network element receives and transmits packets 4, 5, and 6, the destination network element would record the largest sequence number of a packet transmitted as 6. In this example, each of these packets can be a TCP packet and the dataflow is a TCP session between the source and destination hosts. Further, in the same example, if, after receiving and transmitting packet 6, the destination network element receives packet 8 and 10, the destination network element would queue packets 8 and 10 in a queue for this dataflow. If the destination network element further receives packet 7, the destination network element would transmit packets 7 and 8 in order to the destination host, while packet 10 would remain queued.

In addition, and in one embodiment, the destination network element determines which data flows of packets should be queued based on which routes these packets should have. In one embodiment, if the packets are destined for a host that is local to the destination network element and the dataflow is a sequence flow of packets (e.g., a TCP session). For example and in one embodiment, a host that is local to a destination network element is a host that is part of a subnet that is local to that destination network. In this example, the destination network element would be the first hop for a host on a local subnet. In another embodiment, the determination as to which routes should be subjected to queuing can also be determined by a policy associated with the route or a policy associated with the interface carrying the route.

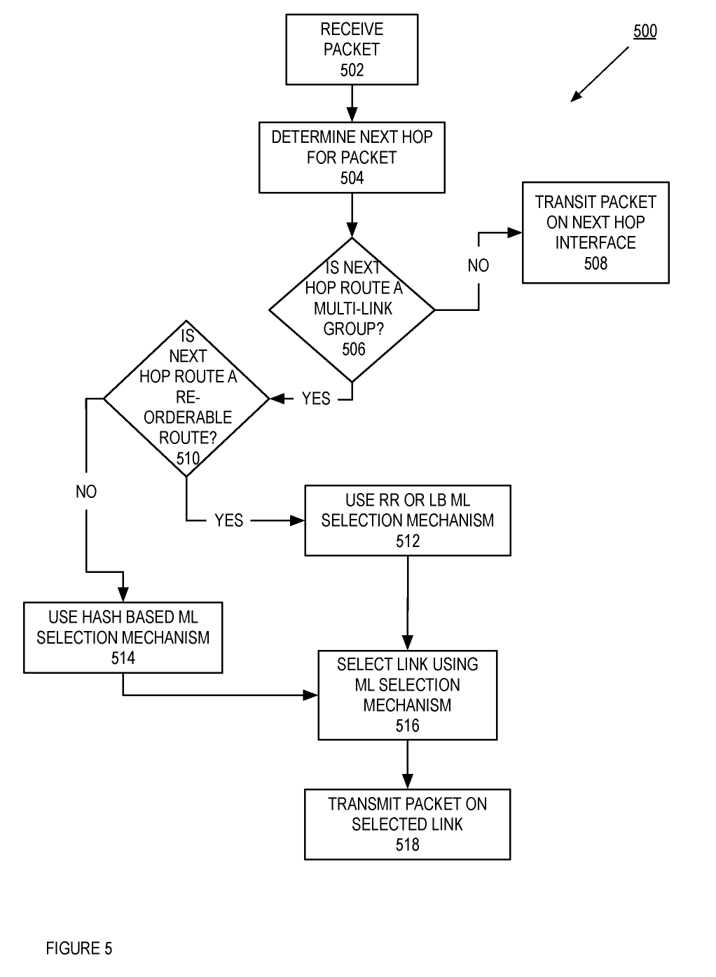

In one embodiment, for each route to a local subnet, the destination network element installs a route to the subnet that indicates this route is a re-orderable route. For example and in one embodiment, in a routing table of the destination network element, a re-orderable route is indicated with a flag (or some other indicator) that indicates that this route is re-orderable. Furthermore, the destination network element advertises this route as a re-orderable route. In one embodiment, by advertising this route as re-orderable, other network elements can use these re-orderable routes to use different link selection mechanisms when one selecting a link from a multi-link group in order to transmit a packet. While in one embodiment, the advertisement of re-orderable routes is illustrated with a leaf-spine architecture, in alternate embodiments, a network element can advertise re-orderable for other types of network architectures. For example and in one embodiment, an egress network element of an autonomous system can advertise a re-ordering capability for routes outside of this autonomous system. In this example, other network elements use this information to select a multi-link next-hop selection algorithm. Advertising a re-orderable route is further described in FIG. 6 below.

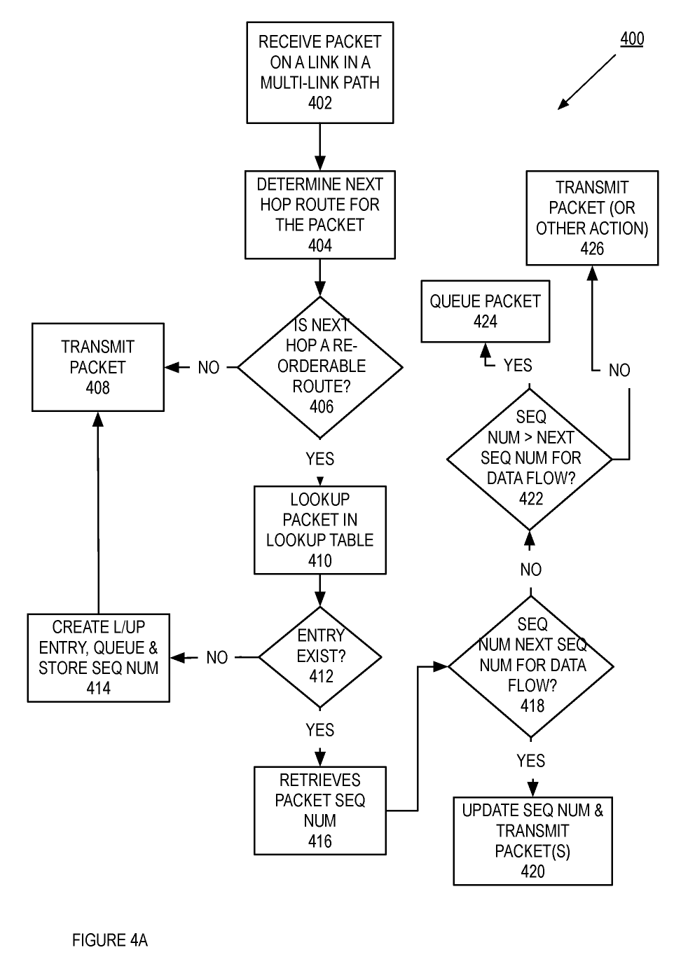

With the re-orderable routes installed in the destination network element, the destination network element can make decisions whether to track packets in a dataflow and to queue out of order packets. In this embodiment, when a destination network element receives a packet, the destination network element looks up the packet based on characteristics in the packet, determines if the packet is out of order, queues the packet if the packet is out of order, and transmits the packet and updates the dataflow sequence number if the packet is in order. Processing packets received by destination network element is further described in FIG. 4A below.

A source network element can take advantage of the destination network and element handling and reordering of the packets, by installing the advertised re-orderable routes in the source network element. In one embodiment, a source network element is a network element that transmits a packet on a path, where the path includes a multi-link group and the source network element makes a decision as to which link of the multi-link group to utilize for this transmission. For example and in one embodiment, each of the leaf network elements 106A-C and the WAN network element 102 can be source network elements, as paths from these network elements can include multi-link groups along these paths (e.g., paths having multi-link groups involving the spine network elements 104A-D). In this example, each of the leaf network elements 106A-C and the WAN network element 102 can be source and/or destination network elements.

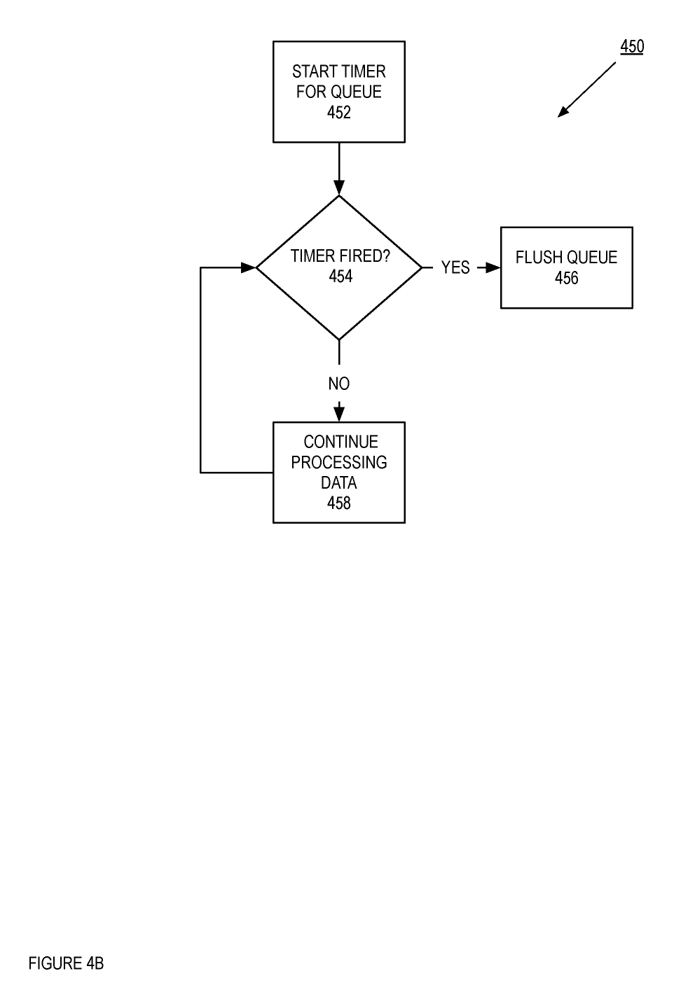

In one embodiment, if a packet is to be routed by a source network element using a re-orderable route that has a next hop that is a multi-link group, the source network element can use a round-robin or load-based link selection mechanism instead of a hash-based link selection mechanism. In this embodiment, the source network element can use the round-robin or load-based link selection mechanism because the destination network element will queue out of order packets. Because the source network element can use the round-robin or load based link selection mechanisms, the utilization of the multiple links will be greater then compared to the source network element using a hash-based link selection mechanism. In one embodiment, if a packet is to be routed by a source network element using a non-re-orderable route that has a next hop that is a multi-link group, the source network element can use a hash-based link selection mechanism. Thus, in these embodiments, which link selection mechanism a source network elements uses for a packet depends on the packets characteristics and the type of route associated with this packet. Determining which link selection mechanism a source network elements uses is further described in FIG. 5 below.

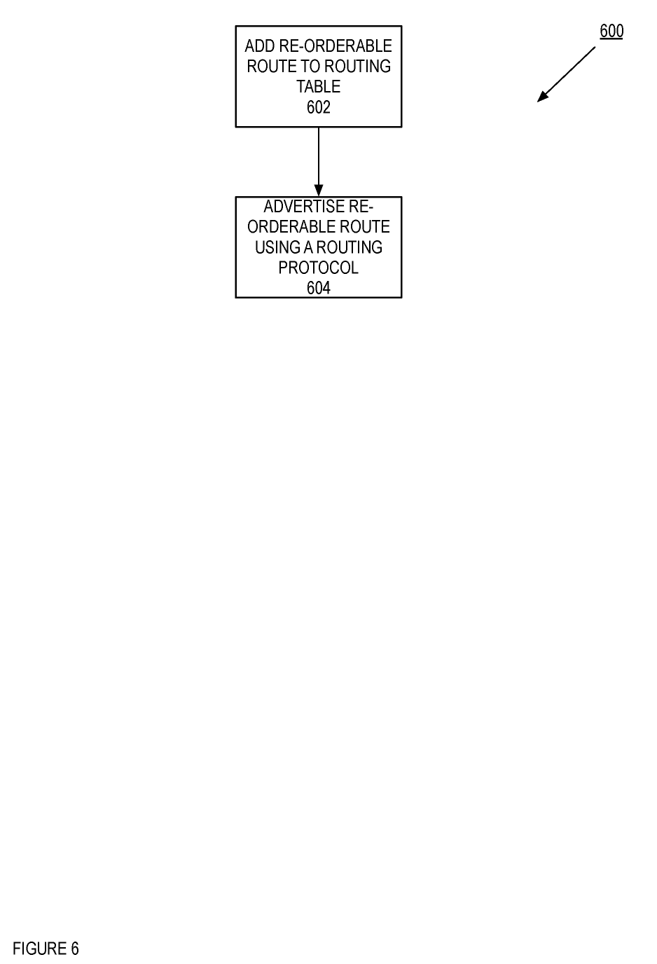

In a further embodiment, the source network element receives and installs re-orderable routes that are advertised using a routing protocol (e.g., OSPF, IS-IS, BGP, centralized routing protocols as are used in Software Defined Networking (SDN) environments (e.g., OpenFlow, OpenConfig, and/or other types of SDN protocols), and/or some other routing protocol that includes extensions that can be used to indicate that a route is re-orderable). In this embodiment, the source network element receives the re-orderable route and installs this re-orderable route in a routing table of the source network element. Receiving and installing the re-orderable route is further described in FIG. 7 below.

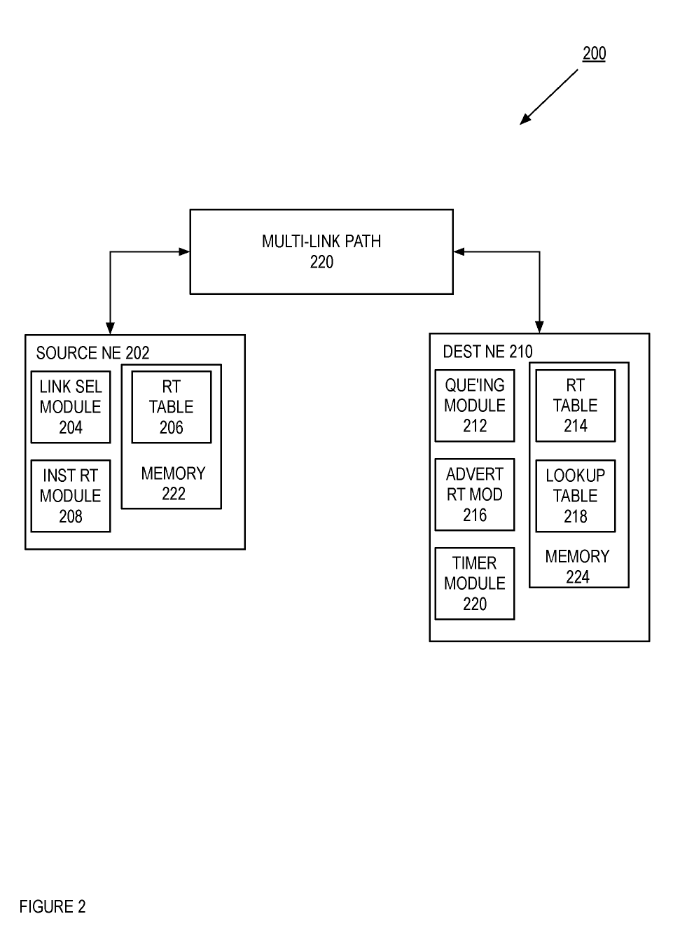

FIG. 2 is a block diagram of one embodiment of source network element 202 coupled to a destination network element 210. In FIG. 2, a system 200 includes a source network element 202 coupled to destination network element 210 via a multi-link path 220. In one embodiment, the source network element 202 transmits packets across the multi-link path 220, where the multi-link path 220 is a path of one or more hops between the source network element 202 and the destination network element 210, with one or more of the hops includes multi-link group. For example and in one embodiment, the multi-link path 220 can include an ECMP group between the source network element 202 and the destination network element 210 as illustrated in FIG. 1 above. In this embodiment, the source network element 202 includes a link selection module 204 that uses different link selection mechanisms to select one of the links of the multi-link group when transmitting packets across this multi-link group. The source network element 202 further includes an install route module 208 that receives and installs routes advertised using a routing protocol in the routing table 206. In one embodiment, the source network element 202 can receive and install a re-orderable route as described above in FIG. 1. In addition, the source network element 202 includes the routing table 206 that stores multiple routes for the source network element 202, where one or more of the routes can be re-orderable routes. In one embodiment, the routing table 206 is stored in memory 222 and a processor of the source network element processes and uses these routes.

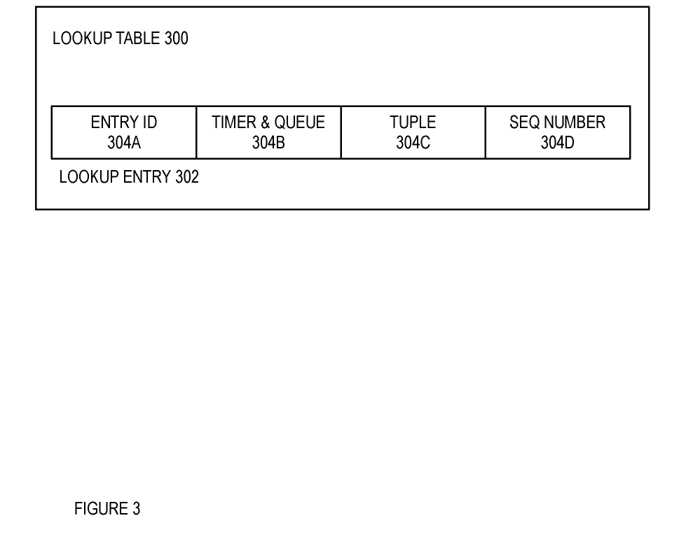

The destination network element 210 is a network element that is on the receiving end of the multi-link path 220 and can queue out of order packets of a dataflow in a queue for that dataflow. In one embodiment, the destination network element 210 includes a queuing module 212 that queues out of order packets and uses a lookup table 218 to keep track of the dataflow sequence numbers transmitted by the destination network element 210. The destination network element 210 further includes an advertising route module 216 that advertises route stored in a routing table 214. In one embodiment the advertising route module 216 advertises re-orderable routes, such as the re-orderable routes described in FIG. 1 above. In addition, the destination network element 210 includes a timer module 220 that is used to flush out of order packets that have been queued too long in an out of order queue. In one embodiment, the destination network element 210 stores the routing table 214 and the lookup table 218 in memory 224. In this embodiment, the routing table 214 stores the routes known to the destination network element 210, which can include re-orderable routes. The lookup table 218 includes entries used to keep track of queues to store out of order packets for the data flows and to track the sequence numbers of those data flows. The lookup table is further described in FIG. 3 below.

FIG. 3 is a block diagram of one embodiment of a lookup table 300 used to keep track of queues to store out of order packets for different data flows. In one embodiment, the lookup table 300 is used to keep track of the queues and timers for each of the data flows, as well as keeping track of the sequence numbers of those data flows. In one embodiment, the lookup table can be a hash table, array, linked list, or another type of data structure used to store and to look up the data. In one embodiment, each entry 302 in the lookup table 300 corresponds to a different dataflow that the destination network element is tracking. In one embodiment, the dataflow can be a sequence number of packets, such as a TCP session. In one embodiment, each entry 302 includes an entry identifier 304A, timer and queue references 304B, tuple 304C, and a sequence number 304D. In one embodiment, the entry identifier 304A is an identifier for the entry. The timer and queue references 304B reference to the queue for this dataflow, where this queue is used to store out of order packets. In one embodiment, the queue can store multiple out of order packets. For example and in one embodiment, if the largest transmitted sequence number for dataflow is sequence number 3, packets for this dataflow that arrive on the destination network element having a sequence number 5 or greater would be out of order and can be queued in an out of order queue for this dataflow. If the destination network element receives packets having a sequence number of 5, 6, and 8 prior to receiving a packet with the sequence number 4, the destination network element queues these packets having the sequence number 5, 6, and 8. If the destination network element receives the packet with sequence number 4, the destination network element would transmit the packets having the sequence numbers 4-6, as these packets are now in order. In a further embodiment, each of these queues includes a corresponding timer that is used to flush packets stored in the queues if these packets our stored too long. In one embodiment, it does not make sense to indefinitely store an out of order packet. In this embodiment, the timer can be set upon queuing an out of order packet and the timer would have a period of approximately the round-trip time for packets in that dataflow.

In one embodiment, the lookup entry 302 further includes a tuple 304C that is a tuple of packet characteristics used to identify a packet in that dataflow if there is an identity collision (e.g., hash collision). In this embodiment, the tuple 304C can be the source and destination IP address, the source and destination port, and/or the packet type (e.g., whether the packet is a TCP or UDP packet). In one embodiment, the lookup table 300 is a hash table where the destination network element hashes each of the packets to determine a lookup entry corresponding to that packet. It is possible that packets from different dataflows may have the same hash. In this case, the tuple 304C is used to distinguish lookup entries for the packets in different data flows. The lookup entry 302 additionally includes sequence number 304D, which is used to store the largest sequence number of the packets for this dataflow transmitted by the destination network element.

FIG. 4A is a flow chart of one embodiment of a process to queue an out-of-order packet received on a multi-link group. In one embodiment, a queuing module queues the out of order packet, such as the queuing module 212 of the destination network element 210 described in FIG. 2 above. In FIG. 4, process 400 begins by receiving a packet on a link transported over a multi-link path at block 402. In one embodiment, a multi-link path is a path from a source network element to a destination network element where one of the hops in the multi-link path includes a multi-link group. At block 404, process 400 determines the next hop route for the packet. In one embodiment, process 400 extracts packet characteristics from the packet (e.g., destination IP address) and uses these packet characteristics to look up a next hop route for the packet. Process 400 determines if the next hop route is a re-orderable route at block 406. In one embodiment, a re-orderable route is a route to a local subnet or host(s) where the destination network element has one or more queue(s) to track data flow(s) for out-of-order packet(s) for these data flow(s). If the route is not a re-orderable route, process 400 transmits the packet using the next hop route at block 408.

If the next hop route is a re-orderable route, process 400 looks up the packet in a lookup table. In one embodiment, the packet is associated with a dataflow (e.g., a TCP session that used this packet). In one embodiment, process 400 looks up the packet based on at least some of the characteristics in the packet. For example and in one embodiment, process 400 computes a hash of these packet characteristics (e.g., source and destination IP address, source and destination port number, and packet type (whether the packet is a TCP or UDP packet)), and looks up the corresponding entry in the table using the hash. If order to avoid a hash collision, process 400 compares the packet characteristics used for the hash computation with the packet characteristics stored in the lookup table entry. Process 400 determines if the lookup table entry exists at block 412. If there is not an entry in the lookup table, process 400 creates the lookup table entry using the packet characteristics, creates the associated queue for packets that are part of the packet data flow, and stores the sequence number of the packet in the lookup entry. Process 400 transmits the packet at block 408.

If the entry does exist, at block 416, process 400 retrieves the packet sequence number. At block 418, process 400 checks if the packet sequence number is the next sequence number for the data flow. In one embodiment, the next sequence number for the data flow is based on the underlying protocol of the data stream and the largest transmitted packet number for that data flow, where the largest transmitted sequence number is stored in the lookup table entry. If the packet sequence number is the next sequence number for the data flow, process 400 updates the sequence number in the lookup table entry for this data flow and transmits this packet and other packet(s) stored in the data flow queue that may be now in order. For example and in one embodiment, if the largest transmitted sequence number for a data flow is 3, with packets 5, 6, and 8 queued, and process 400 receives packet 4 for that data flow, process 400 would transmit packet 4, further transmit packets 5 and 6 as these packet are now in order, and update the largest transmitted sequence number to be 6. While in one embodiment, the packet sequence numbers are identified as monotonically increasing values, in alternate embodiments, the packet sequence numbers are computed based on an underlying protocol (e.g., for a TCP session, the byte number in the TCP stream, where process 400 computes the next sequence number as the current packet sequence number plus the length of the TCP segment).

If the packet sequence number does not equal next sequence number, process 400 checks if the packet sequence number is greater than the next sequence number at block 422. If the packet sequence number is greater than the next sequence number, process 400 queues this packet as an out-of-order packet at block 424. If the packet sequence number is not greater than the next sequence number, this means that packet sequence number is less than the greater than the next sequence number and there is a problem with the data flow between the two end hosts. In one embodiment, process 400 transmits that packet, which lets one of the end hosts to handle this condition.

As described above, process 400 queues out-of-order packets with the idea that when one or more of the out-of-order packets become in-order, process 400 will transmit the previously out-of-order packets. However, an out-of-order packet has the potential to stay in the queue for a long time. In order to alleviate this process, the destination network element can set a timer that limits that length of time an out-of-order packet can remain in the queue. FIG. 4B is a flow chart of one embodiment of a process 450 to handle a timer for a queue flushing operation. In one embodiment, a timer module handles the timer, such as the timer module 220 of the destination network element 210 described in FIG. 2 above. In FIG. 4B, process 450 begins by starting a timer for a queue when a packet is added to the queue at block 452. In one embodiment, there is one queue for the packet(s) stored in the queue and this timer is started when a first packet is stored in an empty queue. If there are subsequent packets stored in this queue, this timer is used to control how long these packets will remain in the queue. In another embodiment, there is a separate timer for each packet in the queue or there can be a timer for each hole in the data session. For example and in one embodiment, assuming the next sequence number is 10 and process 400 queues sequence numbers 12, 13, 14, 16, 17, process 400 could start two timers, one timer at the hole for sequence number 11 and a second timer for the hole at sequence number 15. In this example, having the second timer would give sequence number 15 an adequate amount of time relative to the receipt of sequence number 16. At block 454, process 400 determines if the timer has fired. If the timer has fired, process 450 flushes the queue at block 456. In one embodiment, process 450 flushes the queue by transmitting the packets stored in the queue. In this embodiment, the packets are transmitted at this point since the firing timer indicates that there was indeed a drop and sending mis-ordered packets indicates to the receiver that a packet has been lost in which case the receiver will request a retransmit. If the timer has not fired, process 450 continues to process data at block 458. Execution proceeds to block 454 above.

In one embodiment, when a destination network element queues out-of-order for re-orderable routes, a source network element can use a non-hash based link selection mechanism (e.g., a round robin or load-based link selection mechanism). FIG. 5 is a flow diagram of one embodiment of a process 500 to determine a link selection mechanism for transmitting a packet on a multi-link group. In one embodiment, a link selection module determines a link selection mechanism, such as the link selection module 204 of the source network element 202 described in FIG. 2 above. In FIG. 5, process 500 begins by receiving a packet with a source network element at block 502. At block 504, process 500 determines the next hop for the packet at block 504. In one embodiment, process 500 determines the next hop route by looking up the destination address of the packet in a routing table. Process 500 determines if the next hop route is a multi-link group at block 506. In one embodiment, process 500 determines if the next hop route is a multi-link group by determining if there are multiple interfaces associated with this route. If the route is not a multi-link group, process 500 transmits the packet on the next hop interface.

If the next hop route is a multi-link group, process 500 determines if the next hop route is a re-orderable route at block 510. In one embodiment, process 500 determines if the next hop route is a re-orderable route by an indication (e.g. a flag) associated with the route that indicates the route is a re-orderable route. If the route is re-orderable, process 500 uses a round-robin or load-based link selection mechanism at block 512. In one embodiment, process 500 can use a round-robin or load-based link selection mechanism because this route is re-orderable, where the destination network element will queue any out-of-order packets that may arise by using these link selection mechanisms. Execution proceeds to block 516 below. If the route is not re-orderable, process 500 uses a hash-based link selection mechanism at block 514. As described above, a hash-based link selection mechanism does not have the re-ordering problems as with a round-robin or load-based link selection mechanism, but is not as efficient as these other link selection mechanisms is balancing the load.

With the selected link selection mechanism, process 500 selects one of the links of the multi-link group at block 516. For example and in one embodiment, if process 500 uses a round-robin link selection mechanism, process 500 selects the next link in the round robin to transmit the packet. Process 500 transmits the packet on the selected link at block 518.

As described above, the destination route determines if a local route to a subnet or host is a re-orderable route and advertises this re-orderable route so that a source network elements can take advantage of the re-orderable route and use a round-robin or load-based link selection mechanism for a multi-link group. FIG. 6 is a flow chart of one embodiment of a process 600 to advertise a re-orderable route. In one embodiment, an advertise route module that advertises the route, such as the advertise route module 212 of the destination network element 212 described in FIG. 2 above. In FIG. 6, process 600 begins by adding a re-orderable route to the routing table of destination network element at block 602. In one embodiment, process 600 adds the route by installing the route in the routing table in the destination network element. Process 600 advertises the re-orderable route using a routing protocol at block 604. In one embodiment, process 600 uses an extension in the routing protocol to advertise that the route is a re-orderable route (e.g. OSPF and IS-IS have extension that can be used to advertise re-orderable routes).

When a source network element has a re-orderable route, the source route can take advantage of round-robin or load-based link selection mechanisms when determining which link to use for transmitting a packet using a multi-link group. To use these routes, the source network element will install these routes when the source network element receives the route via a routing protocol advertisement. FIG. 7 is a flow diagram of one embodiment of a process 700 to install a re-orderable route in a routing table. In one embodiment, an install route module that installs a re-orderable, such as the install route module 208 of the source network element 202 described in FIG. 2 above. In FIG. 7, process 700 begins by receiving a re-orderable route at block 702. In one embodiment, a re-orderable route is indicated with a flag (or some other indicator) that indicates that this route is re-orderable and that out of order packets can be queued. At block 704, process 700 installs the route in a routing table of the source network element, where the installed route indicates that this route is re-orderable.

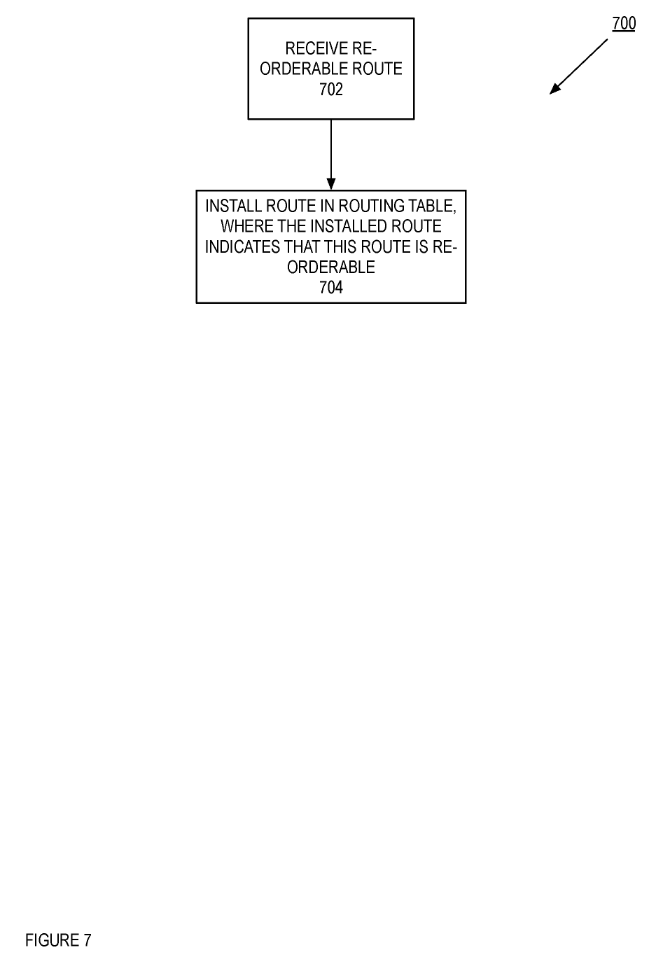

FIG. 8 is a block diagram of one embodiment of a queuing module 212 that queues an out-of-order packet received on a multi-link group. In one embodiment, the queuing module includes a receive packet module 802, determine next hop module 804, re-orderable route check module 806, transmit module 808, lookup module 810, create lookup entry module 812, retrieve sequence number module 814, sequence number check module 816, queue module 818, and update sequence number module 820. In one embodiment, the receive packet module 802 receives the packet as described in FIG. 4A, block 402 above. The determine next hop module 804 determines the next hop route for the packet as described in FIG. 4A, block 404 above. The re-orderable route check module 806 checks if the route is re-orderable as described in FIG. 4A, block 406 above. The transmit module 808 transmits the packet as described in FIG. 4A, block 408 above. The lookup module 810 looks up the packet in the lookup table as described in FIG. 4A, block 410 above. The create lookup entry module 812 creates a lookup entry as described in FIG. 4A, block 414 above. The retrieve sequence number module 814 retrieves the packet sequence number as described in FIG. 4A, block 402 above. The sequence number check module 816 checks the packet and largest stored sequence numbers as described in FIG. 8, blocks 418 and 422 above. The queue module 818 queues the out-of-order packet as described in FIG. 4A, block 424 above. The update sequence number module 820 updates the sequence number and transmits the in order packets as described in FIG. 4A, block 420 above.

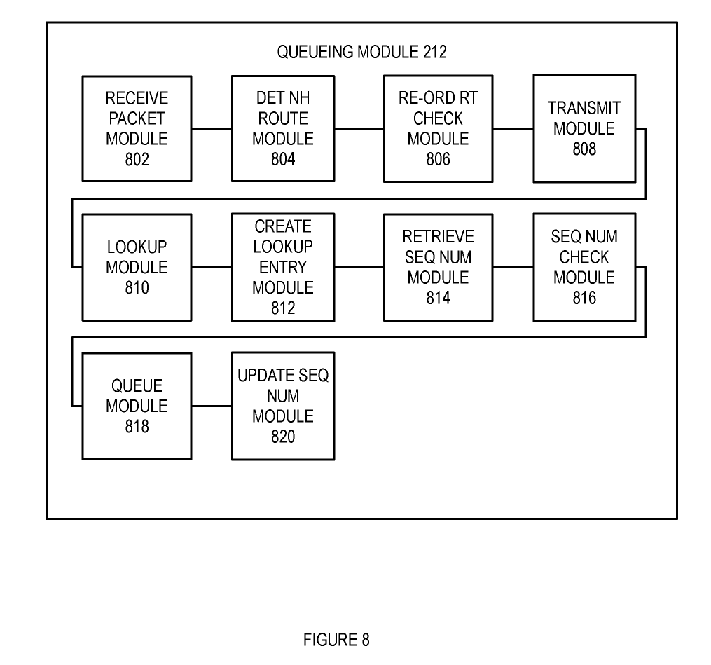

FIG. 9 is a block diagram of one embodiment of a timer module 220 to handle a timer for a queue flushing operation. In one embodiment, the timer module 220 includes a start timer module 902, timer fired module 904, and flush queue module 906. In one embodiment, start timer module 902 starts the timer as described in FIG. 4B, block 452 above. The timer fired module 904 determines if the timer has been fired as described in FIG. 4B, block 454 above. The flush queue module 906 flushes the queue as described in FIG. 4B, block 456 above.

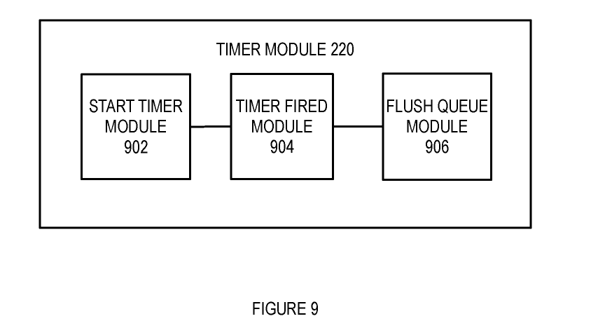

FIG. 10 is a block diagram of one embodiment of a multi-link selection module 204 to determine a link selection mechanism for transmitting a packet on a multi-link group. In one embodiment, the multi-link selection module 204 includes a receive packet module 1002, determine next hop module 1004, multi-link check module 1006, transmit module 1008, re-orderable route check module 1010, use round-robin/load-based selection mechanism module 1012, and use hash-based selection mechanism module 1014. In one embodiment, the receive packet module 1002 receives the packet as described in FIG. 5, block 502 above. The determine next hop module 1004 determines the next hop for the packet as described in FIG. 5, block 504 above. The multi-link check module 1006 checks if the next hop route is a multi-link group as described in FIG. 5, block 506 above. The transmit module 1008 transmits the packet as described in FIG. 5, blocks 508 and 518 above. The re-orderable route check module 1010 determines if the route is re-orderable as described in FIG. 5, block 510 above. The use round-robin/load-based selection mechanism module 1012 uses a round-robin/load-based link selection mechanism as described in FIG. 5, block 512 above. The use hash-based selection mechanism module 1014 uses a hash-based link selection mechanism as described in FIG. 5, block 514 above.

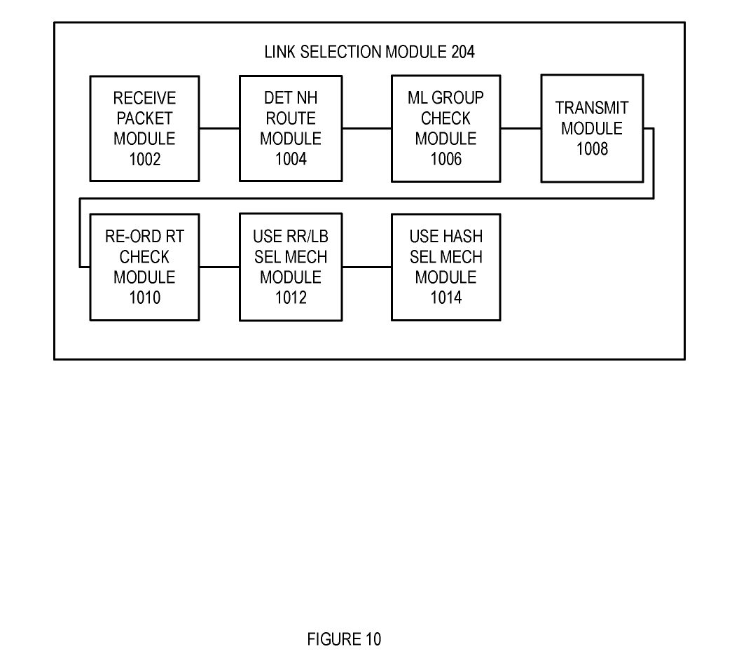

FIG. 11 is a block diagram of one embodiment of an advertise route 216 module to advertise a re-orderable route. In one embodiment, the advertise module 216 includes an add route module 1102 and advertise module 1104. In one embodiment, the add route module 1102 adds the route to the routing table as described in FIG. 6, block 602 above. The advertise module 1104 advertises the route as described in FIG. 6, block 604 above.

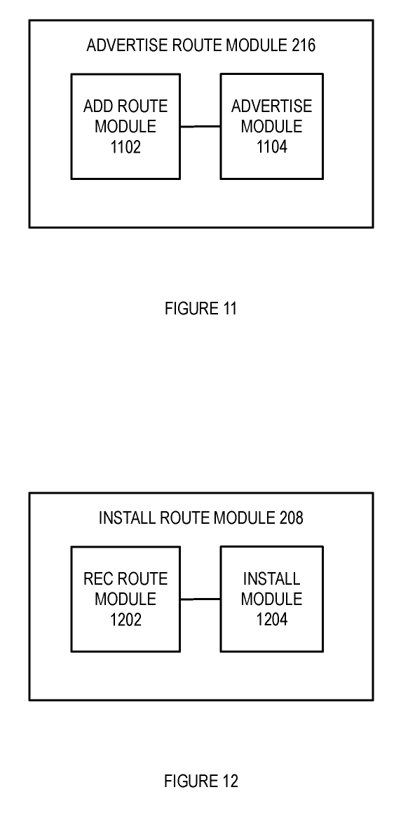

FIG. 12 is a block diagram of one embodiment of an install route 208 module to advertise a re-orderable route in a routing table. In one embodiment, the install route 208 includes a receive route module 1202 and install module 1204. In one embodiment, the receive route module 1202 receives the route as described in FIG. 7, block 702 above. The install module 1204 advertises the route as described in FIG. 7, block 704 above.

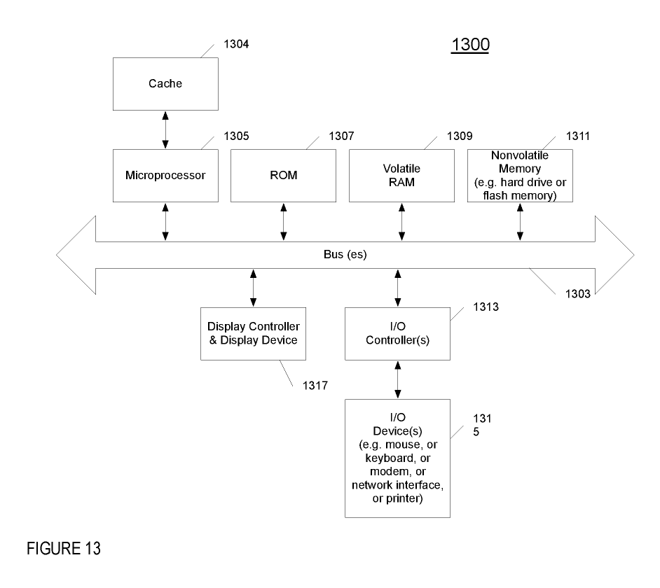

FIG. 13 shows one example of a data processing system 1300, which may be used with one embodiment of the present invention. For example, the system 1300 may be implemented including source and/or destination network elements 202 and 210 as shown in FIG. 2. Note that while FIG. 13 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 13, the computer system 1300, which is a form of a data processing system, includes a bus 1303, which is coupled to a microprocessor(s) 1305 and a ROM (Read Only Memory) 1307 and volatile RAM 1309 and a non-volatile memory 1311. The microprocessor 1305 may retrieve the instructions from the memories 1307, 1309, 1311 and execute the instructions to perform operations described above. The bus 1303 interconnects these various components together and also interconnects these components 1305, 1307, 1309, and 1311 to a display controller and display device 1317 and to peripheral devices such as input/output (I/O) devices which may be mice, keyboards, modems, network interfaces, printers and other devices which are well known in the art. In one embodiment, the system 1300 includes a plurality of network interfaces of the same or different type (e.g., Ethernet copper interface, Ethernet fiber interfaces, wireless, and/or other types of network interfaces). In this embodiment, the system 1300 can include a forwarding engine to forward network date received on one interface out another interface.

Typically, the input/output devices 1315 are coupled to the system through input/output controllers 1313. The volatile RAM (Random Access Memory) 1309 is typically implemented as dynamic RAM (DRAM), which requires power continually in order to refresh or maintain the data in the memory.

The mass storage 1311 is typically a magnetic hard drive or a magnetic optical drive or an optical drive or a DVD ROM/RAM or a flash memory or other types of memory systems, which maintains data (e.g. large amounts of data) even after power is removed from the system. Typically, the mass storage 1311 will also be a random access memory although this is not required. While FIG. 13 shows that the mass storage 1311 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 1303 may include one or more buses connected to each other through various bridges, controllers and/or adapters as is well known in the art.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “process virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

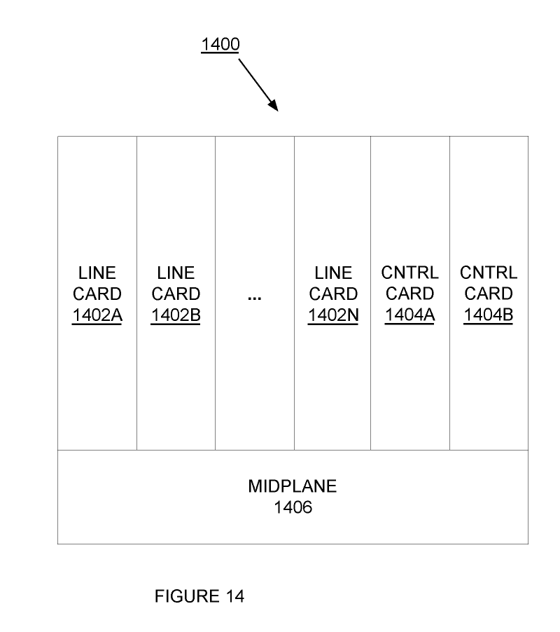

FIG. 14 is a block diagram of one embodiment of an exemplary network element 1400 that queues out of order packets. In FIG. 14, the midplane 1406 couples to the line cards 1402A-N and controller cards 1404A-B. While in one embodiment, the controller cards 1404A-B control the processing of the traffic by the line cards 1402A-N, in alternate embodiments, the controller cards 1404A-B, perform the same and/or different functions (e.g., queuing out of order packets). In one embodiment, the line cards 1402A-N queue out of order packets as described in FIGS. 4A-B. In this embodiment, one, some, or all of the line cards 1402A-N include a queuing module to queue out of order packets, such as the queuing module 212 as described in FIG. 2 above. It should be understood that the architecture of the network element 1400 illustrated in FIG. 14 is exemplary, and different combinations of cards may be used in other embodiments of the invention.

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “identifying,” “determining,” “updating,” “failing,” “signaling,” “configuring,” “increasing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A non-transitory machine-readable medium having executable instructions to cause one or more processing units to perform a method to queue an out-of-order packet received on a multi-link group, the method comprises:
receiving a packet on a link of the multi-link group of a network element, where the packet is part of a data flow of sequenced packets; an
examining the packet if the packet is associated with a re-orderable route, wherein the examining includes,
retrieving a packet sequence number from the packet,
comparing the packet sequence number with the largest transmitted sequence number for this data flow,
transmitting the packet if the packet is a next packet in the data flow, and
queuing the packet if the packet is out-of-order.

2. The machine-readable medium of claim 1, wherein the packet is the next packet in the data flow if the packet sequence number is one greater than the largest transmitted sequence number.

3. The machine readable medium of claim 1, wherein the packet is out-of-order if the packet sequence number is two or more greater than the largest transmitted sequence number.

4. The machine readable medium of claim 3, wherein the examining further comprises:
transmitting the packet if the packet sequence number is less than the largest transmitted sequence number.

5. The machine readable medium of claim 1, wherein the data flow is a Transmission Control Protocol (TCP) session.

6. The machine readable medium of claim 5, wherein the packet is a TCP packet.

7. The machine readable medium of claim 1, wherein the multi-link group is an Equal Cost Multi-Path (ECMP) group.

8. A non-transitory machine-readable medium having executable instructions to cause one or more processing units to perform a method to advertise a re-orderable route from a network element, the method comprising:
determining that the route is the re-orderable route, wherein a re-orderable route is a route that is associated with a queue to store an out-of-order packet; and
advertising the route using a routing protocol from the network element to other network elements coupled to this network element in a network, wherein in the advertised route includes an indication that this route is the re-orderable route.

9. The machine readable medium of claim 8, wherein the route is selected from the group consisting of a local route for the network element and a route defined by a policy as re-orderable.

10. The machine readable medium of claim 8, wherein the route is a route to one or more hosts coupled to the network element.

11. The machine readable medium of claim 8, wherein the routing protocol includes an extension that is used to indicate that the route is a re-orderable route.

12. The machine readable medium of claim 8, wherein the routing protocol is selected from the group consisting of Open Shortest Path First (OSPF), Border Gateway Protocol (BGP), Intermediate System to Intermediate System (IS-IS), OpenFlow, and OpenConfig.

13. A non-transitory machine-readable medium having executable instructions to cause one or more processing units to perform a method to select a link from a multi-link group coupled to a network element, the method comprising:
receiving a packet on the network element;
determining a next hop route for the packet, wherein the next hop route includes multi-link group that include a plurality of interfaces;
designating a first link selection mechanism as a link selection mechanism if the next hop route is a re-orderable route;
designating a second link selection mechanism as the link selection mechanism if the next hop route is not a re-orderable route;
selecting a transmission interface from the plurality of interfaces using the link selection mechanism; and
transmitting the packet using the transmission interface.

14. The machine readable medium of claim 13, wherein the multi-link group is an Equal Cost Multi-Path (ECMP) group.

15. The machine readable medium of claim 13, wherein the packet is a Transmission Control Packet (TCP).

16. The machine readable medium of claim 13, wherein the re-orderable route is a route that is associated a queue to store an out-of-order packet after being transmitted across the selected transmission interface.

17. The machine readable medium of claim 13, wherein the first link selection mechanism is selected from the group consisting of a round robin and a load based link selection mechanism.

18. The machine readable medium of claim 13, wherein the second link selection mechanism is a hash based link selection mechanism.

19. A method to queue an out-of-order packet received on a multi-link group, the method comprises:
receiving a packet on a link of the multi-link group of a network element, where the packet is part of a data flow of sequenced packets; an
examining the packet if the packet is associated with a re-orderable route, wherein the examining includes,
retrieving a packet sequence number from the packet,
comparing the packet sequence number with the largest transmitted sequence number for this data flow,
transmitting the packet if the packet is a next packet in the data flow, and
queuing the packet if the packet is out-of-order.

20. A method to advertise a re-orderable route from a network element, the method comprising:
determining that the route is the re-orderable route, wherein a re-orderable route is a route that is associated with a queue to store an out-of-order packet; and
advertising the route using a routing protocol from the network element to other network elements coupled to this network element in a network, wherein in the advertised route includes an indication that this route is the re-orderable route.

21. A non-transitory machine-readable medium having executable instructions to cause one or more processing units to perform a method to select a link from a multi-link group coupled to a network element, the method comprising:
receiving a packet on the network element;
determining a next hop route for the packet, wherein the next hop route includes multi-link group that include a plurality of interfaces;
designating a first link selection mechanism as a link selection mechanism if the next hop route is a re-orderable route;
designating a second link selection mechanism as the link selection mechanism if the next hop route is not a re-orderable route;
selecting a transmission interface from the plurality of interfaces using the link selection mechanism; and
transmitting the packet using the transmission interface.
